(19) United States
(12) Patent Application Publication
(10) Pub. No.: US 2015/0025294 A1
(43) Pub. Date: Jan. 22, 2015

(54) Decontamination Method for Radioactively Contaminated Material

(71) Applicant: ALD Vaccum Technologies GmbH, Hanau (DE)

(72) Inventors: Karl-Heinz Grosse, Grundau (DE); Richard Seemann, Hanau (DE)

(21) Appl. No.: 14/375,268

(22) PCT Filed: Feb. 13, 2013
(86) PCT No.: PCT/EP2013/052912

§ 371 Date: Jul. 29, 2014

(30) Foreign Application Priority Data
Feb. 14, 2012 (DE) 10 2012 101 161.3
Feb. 14, 2012 (DE) 10 2012 101 165.6

(51) Int. Cl. G21F 9/00; G21F 9/30

(52) U.S. Cl. CPC G21F 9/002; G21F 9/30
USPC 588/19

(57) ABSTRACT

This invention relates to a method for decontaminating radioactively contaminated material, for example construction waste. The material is comminuted by means of voltage pulses and can be divided with a high degree of selectivity into non-contaminated or only weakly contaminated material and contaminated remainder. The majority therefore represents non-contaminated or only weakly contaminated waste material which can be disposed of much more easily than the contaminated remainder. Therefore, the method is particularly suitable for reducing the volume of radioactive waste material which is subject to stringent safety requirements in respect of its storage and disposal and therefore its storage and disposal incur high costs.

This invention relates to a method for separating radionuclides from contaminated material, for example construction waste. The method according to the present invention is suitable for isolating non-contaminated or only weakly contaminated material from the total volume of the contaminated material with a high degree of selectivity, thus for nearly completely separating contaminants (radionuclides) respectively contaminated material phases. So the volume of such material requiring a particularly complex and thus particularly costly disposal and storage can significantly be decreased which is also highly advantageous with respect to the strongly limited storage possibilities. The material being no longer or only weakly contaminated can be disposed of or appropriately recycled and reused under lower safety requirements.

The disposal and storage of radioactive material, such as for example construction waste or also graphite, are very costly. Stringent safety regulations have to be satisfied so that the requirements for containers and disposal sites of radioactive material cause very high costs.

In particular the disposal of contaminated construction waste results in high amounts of material which has to be stored and disposed of in a costly manner. However, contaminated concrete structures of nuclear plants are normally only contaminated at their surface. Therefore, the removal of contaminated surfaces and their treatment as a separate waste stream can result in a considerable reduction of the amount of radioactive waste from the building structures.

Furthermore, not all material phases of the concrete are contaminated equally. So, not the portions of gravel which are present in the concrete as material phases, but the cement phases which are present between the gravel are loaded with the contaminations. Thus, with an exact separation of the gravel from the cement phases a further reduction of waste could be achieved.

A possible clearance measurement of construction waste from nuclear plants significantly depends on the homogenous distribution of the waste material in the waste package. With the division of the construction waste into the material phases gravel and cement, thus into fine-grained cement phases and coarser loose gravel fill, furthermore a nearly homogenous filling of waste packages would be possible.

Building structures being contaminated at the surface may be removed by milling, alternating thermal loads or microwave treatment. The disadvantage of these methods is a high dust exposure, when a division into the material phases, thus into the gravel phase and the cement phase, should be achieved which is as complete as possible. A further disadvantage is the comminution of the gravel portions as well as the incomplete separation of the contaminated cement phases from the gravel.

A further possibility is disassembling of whole building structures with conventional demolition tools or by targeted sawing. In the case of direct disposal of construction waste such obtained in particular the inhomogeneous distribution in the waste package has a negative influence onto a possible clearance measurement, since the inhomogeneous distribution results in higher safety limits of the measurement. By coarse comminution of the construction waste the homogeneity in the waste package can be improved. But this is not sufficient. In a next step the gravel phase can be separated from the cement phase by sieving. Here it has been shown that the adhesion residue of the cement phase at the gravel mostly is still too high for achieving a complete decontamination of the gravel.

Also each year large amounts of contaminated graphite accumulate as contaminated material. Namely, there is a plurality of different graphite-moderated nuclear reactors worldwide, such as for example UNGG in France, Magnox and AGR in England or RBMK in Russia. These reactors are normally gas-cooled and use metal-encased fuel elements which are packaged in so-called sleeves of graphite and are moved in the reactor core in this condition. As a core material for this kind of reactors normally appropriate graphite blocks are used which serve as thermal insulation, as moderator for the absorption of free neutrons and also as gas line elements.

When such a reactor is demolished (there are ca. 240,000 t of such graphite components worldwide), besides the problem of the removal of such graphite components there is the problem of the final disposal at a later date. A simple final disposal near the surface of such components in containers filled with concrete has not been approved till today worldwide, since the spread of the contained radionuclides cannot definitely be prevented and is a great danger for the environment and the existence of all life. However, a final disposal in geological formations deep under the surface is costly and requires in addition the comminution of the voluminous graphite blocks which partially comprise voids for appropriately minimizing the required storage capacity.

There are attempts to separate the contaminated materials from the remainder of the graphite by a thermal treatment, and there are research studies about this subject of several years. But till today, such a method has not get beyond this stage.

Therefore it is the object of the present invention to provide a method which allows the removal of contaminants (radionuclides) from material being contaminated with radionuclides, for example construction waste, with a high degree of selectivity. The term “contaminated” is used synonymously according to the present invention with the term “contaminated with radionuclides”. In many cases in the contaminated material Cs-137 and/or Co-60 and/or Sr-90+ and/or Pu-239 and/or U-235 and other radioactive isotopes of uranium and/or Th-232 and other radioactive isotopes of thorium, and/or Pb-203 and other radioactive isotopes of lead, and/or C-14 and/or Cl-36 are present. This list is an exemplary and not a limiting one. In the material any desired other radionuclides may be present. When one of the above-mentioned radionuclides is present in the material, then this can be a single one. It is also possible that mixtures comprising at least two or more of the mentioned radionuclides are present in the material. Such mixtures may in addition comprise also further radionuclides which are not explicitly mentioned here.

In the case of contaminated construction waste the present radionuclides are in particular Cl-36 and/or C-14. Also possible are radionuclides which are selected from one or more of Cs-137, Co-60 and Sr-90+.

Contaminated graphite may comprise radionuclides of uranium, thorium and/or plutonium.

The method described and claimed here for separating radionuclides from contaminated material, such as for example construction waste, solves the above-mentioned object.

According to the present invention the term “separating of radionuclides” means that from the contaminated material a non-contaminated or only weakly contaminated material which is referred to as decontaminated according to the present invention is isolated. Thus, with the method according to the present invention the contaminated material is divided into decontaminated material and contaminated remainder which normally has a relatively small volume.

A person skilled in the art knows what non-contaminated, weakly contaminated and contaminated means. He will consult his general expert knowledge and well-known relevant guidelines. Such a guideline is for example a current Radiation Protection Ordinance with annexes.

For example total activities of ≦40 Bq/g is a value which may correspond to a weak contamination. A person skilled in the art also knows that the values of the total activity and the classification based thereon strongly depend on the respective radionuclide which is responsible for the contamination.

Further examples for weak contamination are ≦10 Bq/g, ≦7 Bq/g, ≦6 Bq/g, ≦1 Bq/g, ≦0,6 Bq/g, ≦0,5 Bq/g, ≦0,1 Bq/g, ≦0,04 Bq/g, ≦0,004 Bq/g, ≦0,003 Bq/g.

The contaminated remainder comprises the contaminants (radionuclides) in isolated form. Optionally, the contaminated remainder may in addition comprise contaminated material phases. The contaminated remainder may also comprise fractions of contaminated material phases with different contamination. Here the method according to the present invention allows a nearly complete division of the contaminated material into decontaminated material and contaminated remainder, thus a nearly complete separation of the radionuclides according to the present invention.

A typical contaminated material is for example graphite, in particular graphite resulting from demolition of nuclear power plants. In this material the content of radionuclides in comparison to the total volume of the material is relatively low. To date, nevertheless the total volume has to be disposed of as nuclear waste in a proper way. Normally, graphite is used in nuclear reactors in a highly compressed form. For this purpose at first a graphite powder is processed into a granulate which is then compressed into a graphite matrix. During the compression at the granulate grain boundaries external elements are inevitably adsorbed. Nitrogen is an example for such an external element. Due to the irradiation during the operation of the reactor besides other decay products the carbon isotope C-14 and the chlorine isotope Cl-36 are created. It has been found that these radionuclides are strongly accumulated in the region of the grain boundaries of the contaminated material.

Also construction waste may be contaminated material. It contains in particular material phases having varyingly strong contamination, thus varyingly strong load with contaminants, namely a non-contaminated or only weakly contaminated gravel phase and a contaminated cement phase.

The contaminated material is preferably selected from graphite, construction waste or mixtures thereof. The method according to the present invention is particularly advantageous for contaminated construction waste, because with the method according to the present invention in the case of contaminated construction waste the amount of material which has to be stored under stringent safety precautions can considerably be reduced. The reason for that is that with the method according to the present invention an isolation of the non-contaminated or only weakly contaminated material phases, in particular the gravel phase, from the contaminants and contaminated material phases, in particular the cement phase, becomes possible. So in particularly preferable embodiments of the method according to the present invention construction waste is used as contaminated material. In particular, the contaminated material is construction waste which arises in the case of demolition of nuclear power plants and/or nuclear facilities for open handling of radionuclides. Besides a gravel phase and a cement phase the construction waste may also contain further phases and/or components, such as for example metals. With the method according to the present invention they can also be separated in an effective manner.

With the method according to the present invention it is possible to separate the small volume of the radioactive remainder, thus of contaminants and of optionally contaminated material phases from the total volume of the contaminated material with a high degree of selectivity and thus to isolate decontaminated material. As a result, only the normally relatively small volume of the contaminated remainder has to be disposed of in a complex manner.

The decontaminated material, thus the non-contaminated or only weakly contaminated material can be disposed of in a less complex manner.

The method according to the present invention is a method for the separation of radionuclides from contaminated material, for example construction waste, comprising the steps of
placing of the contaminated material in a container containing a liquid and comprising at least one first and one second electrode;
inducing of at least one voltage pulse between the electrodes so that the contaminated material is comminuted, wherein the radionuclides are accumulated in the liquid;
optionally dividing of the contaminated material into at least one contaminated and at least one non-contaminated or only weakly contaminated material phase; for example cement phase and gravel phase in the case of construction waste as contaminated material;
separating of solid and liquid constituents; and
isolating of the radionuclides from the liquid constituents.

The fact that the container comprises a first and a second electrode does not mean that the electrodes are a component of the container. They can also be designed such that they are fixed in such a manner that they extend into the liquid or otherwise extend into the container. Preferably, the container comprises a non-conductive material, such as in particular plastic. Polyethylene has been shown to be particularly suitable. Preferably, the container is located inside a reactor.

Thus, the separation of the radionuclides from contaminated material comprises according to the present invention a step in which at least one voltage pulse is induced between the electrodes so that the contaminated material is comminuted in the liquid, wherein contaminants (radionuclides) are accumulated in the liquid.

Optionally, a division of the contaminated material into at least one contaminated and at least one non-contaminated or only weakly contaminated material phase may follow, in particular a division into a non-contaminated or only weakly contaminated gravel phase and a contaminated cement phase, for example when the contaminated material is construction waste. Such a process step is in particular advantageous, when the contaminated material consists of different phases which are loaded with different degrees of contaminants, and in particular, when the radionuclides cannot sufficiently be released from one of the material phases into the liquid so that non-contaminated or only weakly contaminated material phase would remain.

According to the present invention a material phase is the total sum of the constituents of a material which shows the same physical and chemical properties and is different from other material constituents of a material. Material phases are for example gravel and cement which are contained in construction waste. So contaminated construction waste as preferred contaminated material comprises the material phases gravel and cement which due to the different properties have a different degree of contamination. Furthermore, in the method according to the present invention the radionuclides often cannot sufficiently be released from the cement phase into the liquid. In particular in the case of construction waste as contaminated material it is therefore particularly preferable in the method according to the present invention to divide the contaminated material into contaminated and non-contaminated or only weakly contaminated material phases, in particular into cement and gravel phases. Thus, when the contaminated material is construction waste, then the method according to the present invention preferably comprises the process step of dividing the contaminated material into contaminated and non-contaminated or only weakly contaminated material phases, particularly preferable into a contaminated cement phase and a non-contaminated or only weakly contaminated gravel phase.

The method according to the present invention in addition comprises the step of separating solid and liquid constituents, preferably by separating the liquid constituents. According to the present invention the liquid constituents comprise the liquid and the radionuclides from the contaminated material. According to the present invention the solid constituents comprise the non-contaminated or only weakly contaminated material, for example gravel or decontaminated graphite.

In embodiments in which the method according to the present invention comprises the division of the contaminated material into contaminated and non-contaminated or only weakly contaminated material phases, the solid constituents in addition contain the contaminated material phase, for example cement. In such embodiments preferably after the separation of the solid and liquid constituents a further step of separating the non-contaminated or only weakly contaminated material phase from the contaminated material phase follows, preferably by sieving. So, when the contaminated material is construction waste, then the solid constituents contain gravel and cement phase, wherein after the separation of the solid and liquid constituents preferably the gravel phase is separated from the cement phase, thus non-contaminated or only weakly contaminated material phase is separated from contaminated material phase. This is preferably conducted by sieving.

After the step of separating the solid from the liquid constituents the method according to the present invention further comprises a step comprising the isolation of the radionuclides from the liquid constituents. After the isolation of the radionuclides the disposal of the radionuclides as radioactive waste in a proper way may follow.

The method according to the present invention uses the technique of electrodynamic fragmentation as is also described in DE 195 34 232 A1. Herewith by reference the application DE 195 34 232 A1 is incorporated in its entirety into this description. In this method by the voltage pulse which is induced between the electrodes a shock wave is caused in the contaminated material. This shock wave results in comminution of the contaminated material. In this case the use of the technique of electrodynamic fragmentation is particularly advantageous and allows the nearly complete separation of the radionuclides from the contaminated material. In addition, so lower discharge currents and energy inputs are required which on the one hand allows a cost-effective conduction of the method and on the other hand protects the components. According to the present invention the comminution of the contaminated material with a high degree of selectivity at first takes place at grain or phase boundaries.

By the fact that the method according to the present invention involves the comminution of the contaminated material by electrodynamic fragmentation, it results in selective comminution of the material along the grain boundaries. So the radionuclides can be released and are accumulated in the liquid. Then, the liquid constituents can easily be separated from the solid constituents and the radionuclides can be isolated from the liquid constituents.

In addition it may be that by the comminution of the contaminated material by electrodynamic fragmentation a selective division into material phases becomes possible, in particular into a non-contaminated or only weakly contaminated coarse-grained gravel phase and a contaminated fine-grained cement phase, for example when the contaminated material is construction waste. According to the present invention it is preferable, when the contaminated material is construction waste.

The liquid used has to fulfill some requirements: it has to have only a very low conductivity and furthermore a sufficient dissolving power for radionuclides. Water, halogenated hydrocarbons and silicone oils as well as mixtures thereof have shown to be suitable liquids. Thus, the liquid preferably comprises water, halogenated hydrocarbons and/or silicone oils. The halogenated hydrocarbons are preferably chlorinated and/or fluorinated alkanes. Particularly preferable is water, because water is inexpensive and the disposal of the water does not involve any greater problems.

If possible, the liquid should only comprise low amounts of dissolved ions, because otherwise the conductivity thereof may become too high. In the case of water the use of deionized water has shown to be particularly advantageous.

For increasing the solubility of the radionuclides in the liquid, to the liquid solubilizers may be added. As solubilizers preferably complexing agents, surfactants or mixtures thereof are used. The complexing agents directly increase the solubility of the radionuclides by complex formation, whereas the surfactants improve the wettability of the contaminated material. In addition, they decrease the conductivity.

Furthermore, the surfactants may promote foaming. Normally, this is not desired. But in the present case with a kind of flotation a possible fine fraction, in particular a cement phase can be removed from the liquid. Preferably, the step of flotation follows the comminution of the contaminated material and the optional division of the material into the material phases.

A further preferable additive for the liquid is a further water-immiscible liquid phase, in particular an organic oil or a mixture of organic oils. This further phase preferably contains a silicone oil and/or an alkane with a chain length of at least 6 and at most 18 carbon atoms, e.g. dodecane, which with the added surfactants forms an emulsion and extracts the complexed ions from the aqueous phase and thus further reduces the conductivity of the liquid. Preferably, the further liquid phase is added in an amount resulting in a concentration of at most 50% by volume of the liquid, wherein at most 20% by volume are particularly preferable. The minimum content of the further liquid phase in the liquid is preferably at least 1% by volume, further preferably at least 5% by volume and particularly preferably at least 10% by volume. Thus, the liquid may be a two-phase system, in particular an emulsion.

Preferable complexing agents are organic complexing agents, in particular nitrilo-triacetic acid (NTA), ethylene glycol bis(aminoethylether)-N,N′-tetraacetic acid (EGTA), ethylenediamine disuccinic acid (EDDS), ethylenediamine tetraacetic acid (EDTA), citric acid, polycarboxylates, oxalic acid, carbamoyl methylphosphine oxide (CMPO), crown ethers and mixtures thereof. Particularly preferable complexing agents are CMPO, crown ethers, oxalic acid and mixtures thereof.

Also the surfactants are preferably organic molecules; in particular they are non-ionic surfactants.

The complexing agents are preferably used in a concentration of at least 0.0001 mol/l, further preferably at least 0.001 mol/l and particularly preferably at least 0.01 mol/l. Below these values the effect is not very high. At the same time the content of these substances should not exceed values of preferably at most 1 mol/l and further preferably at most 0.1 mol/l. When too much complexing agent is used, then the conductivity of the liquid increases.

The surfactants are preferably used in a concentration of at least 0.00005 mol/l, further preferably at least 0.002 mol/l and particularly preferably at least 0.01 mol/l. Below these values the effect is not very high. At the same time the content of these substances should not exceed values of preferably at most 1 mol/l and further preferably at most 0.05 mol/l. When too much surfactant is used, then the tendency of the liquid to the formation of foam is very high, by which contamination of other parts of the facility may be caused.

A further preferable additive in the liquid are oxidizing substances. The oxidizing substances enhance the purification effect, because the surface of the contaminated material is partially oxidized and thus chemically bound elements can be detached better. The oxidizing substances are preferably used in concentrations of at least 0.0001 mol/l, further preferably at least 0.01 mol/l and particularly preferably at least 0.05 mol/l. Concentrations below these values do not result in effects which are very high. At the same time the content of these substances should not exceed values of preferably at most 2 mol/l and further preferably at most 0.1 mol/l. When the concentration of the oxidizing substances is too high, then the container will be attacked, by which the useful working life of the facility is decreased.

Preferably used oxidizing substances are organic peroxides, chromates, manganates and mixtures thereof. Organic peroxides are particularly preferable oxidizing substances, because the conductivity of the liquid is only slightly influenced.

It has been shown that the purification efficiency is particularly high, when the pH of the liquid is chosen either particularly high or particularly low. Preferably, the pH is in a range of 0.5 to 3 or in a range of 9 to 12.

For the adjustment of the pH value of the liquid substances can be added, wherein for the adjustment of an alkaline pH inorganic hydroxides, such as in particular KOH and/or NaOH can be used. For the adjustment of an acidic pH preferably mineral acids, such as in particular HCl and H₂SO₄ are used.

In preferable embodiments the liquid consists of water, further preferably deionized water, and particularly preferably it does not contain additives such as solubilizers, oxidizing substances or substances for the adjustment of the pH value. A further advantage in this case is that the method can be conducted still more inexpensively and that the resulting liquid constituents after the isolation of the radionuclides can in addition be disposed of or recycled very easily and without any further reprocessing.

The number of the voltage pulses used depends on the material to be decontaminated. Typically, at least 5 voltage pulses will be required, preferably even at least 50 or at least 100 voltage pulses and particularly preferably at least 600 voltage pulses. So that the degree of comminution of the material does not become too high, that is comminution beyond the grain boundaries, the number of the voltage pulses should be limited to a maximum of 10.000, further preferably a maximum of 5.000 and particularly preferably a maximum of 1.500. When the material is comminuted beyond the grain boundaries, then the particle size of the material becomes so small that these particles during the step of separating into liquid and solid constituents find their way into the liquid constituents. So the purification efficiency will be compromised.

The time period of a voltage pulse is preferably at least 1 ns and at most 1 ms, in particular at least 100 ns and at most 100 μs.

When the material is treated with the voltage pulses, then preferably frequencies of at least 0.5 Hz, further preferably at least 1 Hz and particularly preferably at least 3 Hz are used. Preferably, this frequency is at most 1 kHz, further preferably at most 500 Hz, more preferably at most 100 Hz and particularly preferably at most 50 Hz.

The comminution is preferably conducted with an energy of at least 10 and at most 300 J/cm.

Preferably, the voltage pulses work with average voltages of at least 50 kV, further preferably at least 100 kV and particularly preferably at least 140 kV. Otherwise, dependent on the material often not sufficient comminution takes place. At the same time also the average voltage should not be too high, because otherwise comminution beyond the grain boundaries of the material takes place and in addition the equipment is affected badly. Therefore, the average voltage is preferably at most 1 MV and further preferably at most 400 kV.

The liquid constituents contain radionuclides from the contaminated material. In a process step the radionuclides are isolated from the liquid constituents. Possible methods for isolating the radionuclides from the liquid constituents are selected from
evaporating/drying the liquid,
precipitating the radionuclides,
removing the radionuclides by means of ion exchanger or
flotation.

Also combinations of these methods may be used. After the precipitation step and the evaporation step then a filtration step may follow.

The radionuclides isolated from the liquid constituents can then be disposed of in a proper way. In this case for example the embedment in hollow graphite bodies may be used. Suitable are for example waste packages as are described in WO 2011/117354 A1 and WO 2010/052321 A1. Both applications are incorporated into this description in their entirety by this reference.

An advantage of the method according to the present invention is that the comminution of the contaminated material is not conducted in dry condition. So the formation of dust is prevented. In this case the purpose of the liquid is the prevention of the formation of dust and the absorption of radionuclides for further processing.

In embodiments in which the method according to the present invention comprises the division of the contaminated material into contaminated and non-contaminated or only weakly contaminated material phases, in particular into a cement and a gravel phase, these material phases can be introduced into waste packages and permanently disposed of separately from each other. Suitable are for example waste packages as are described in WO 2011/117354 A1 and WO 2010/052321 A1.

The number and the amplitude of the voltage pulses are selected such that the contaminated material will be comminuted along its grain boundaries. Further comminution should not take place; in particular substantially no C-C bonds are cleaved.

### EXAMPLES

### Example 1

437 g of construction waste with a cement and a gravel fraction having a grain size of between 2 cm and 5 cm and a total β/γ activity of 187 Bq were treated by the method according to the present invention. The average voltage was 130 kV, the number of the pulses was 16 at a frequency of 5 Hz.

The following table shows that the construction waste has been divided into decontaminated material and contaminated remainder. The fractions of the contaminated remainder show different activity. Substantially the decontaminated material represents gravel phase with only very low activity. So the mass of the material with high activity has been strongly decreased and the non-contaminated or only weakly contaminated material can be disposed of much more easily.

| | Decontaminated | | | | |
|---|---|---|---|---|---|
| | material | | Contaminated remainder | | |
| | Fraction 1 | | Fraction 2 | Fraction 3 | Liquid |
| Grain size | >2 | mm | <2 mm > 0.5 | <0.5 | |
| Mass [g] | 349 | | 65 | 17 | — |
| Total β/γ | <1 | | 4.6 | 129 | 52 |
| activity [Bq] | | | | | |

### Experiment 2

Graphite blocks having an edge length of 2 cm each were placed in a container and comminuted with voltage pulses in water. The powder obtained had a grain size of 20 to 50 μm. The following table shows some data of the experiment:

| | |
|---|---|
| Number of voltage pulses | 1240 |
| Average voltage | 150 kV |
| Pulse frequency | 5 Hz |
| Electrode gap | 25 mm |

### Experiment 3

A graphite granulate having a grain size of 500 μm to 2 mm was placed in a container. The graphite granulate was contaminated with the radionuclide Cl-36 in a proportion of 5 μg/kg. Comminution was conducted in water. Thereafter the water was separated and the Cl-36 which was now present in the granulate having been comminuted to grain sizes of 10 to 50 μm was quantitatively determined. The content of Cl-36 was only <0,1 μg/kg. The following table shows some parameters of the experiment:

| | |
|---|---|
| Number of voltage pulses | 936 |
| Average voltage | 160 kV |
| Pulse frequency | 5 Hz |

1. Method for separating radionuclides from contaminated material, for example construction waste, comprising the steps of
placing of the contaminated material in a container containing a liquid and comprising at least one first and one second electrode;
inducing of at least one voltage pulse between the electrodes so that the contaminated material is comminuted, wherein the radionuclides are accumulated in the liquid;
optionally dividing of the contaminated material into at least one contaminated and at least one non-contaminated or only weakly contaminated material phase;
separating of solid and liquid constituents; and
isolating of the radionuclides from the liquid constituents.

2. Method according to claim 1, wherein the liquid comprises water, halogenated hydrocarbons, silicone oil or a mixture of these liquids.

3. Method according to claim 1 or 2, wherein the method comprises the division of the contaminated material into at least one contaminated and at least one non-contaminated or only weakly contaminated material phase and wherein a contaminated material phase is cement and a non-contaminated or only weakly contaminated material phase is gravel.

4. Method according to claim 3, wherein the contaminated cement phase and the non-contaminated or only weakly contaminated gravel phase after the step of separating of solid and liquid constituents are separated from each other, preferably by sieving.

5. Method according to at least one of the preceding claims, wherein the contaminated material is construction waste.

6. Method according to at least one of the preceding claims, wherein the isolation of the radionuclides from the liquid constituents is conducted by a method, selected from evaporating/drying the liquid, precipitating the radionuclides, removing the radionuclides by means of ion exchanger, flotation or mixtures thereof.

7. Method according to at least one of the preceding claims, wherein the liquid comprises at least one solubilizer, selected from complexing agent, surfactant or mixtures thereof.

8. Method according to at least one of the preceding claims, wherein the liquid comprises an oxidizing substance.

9. Method according to at least one of the preceding claims, wherein the liquid is an emulsion.

10. Method according to at least one of the preceding claims, wherein at least 5 and at most 10.000 voltage pulses are induced.

11. Method according to claim 7, wherein the complexing agent is selected from nitrilo-triacetic acid (NTA), ethylene glycol bis(aminoethylether)-N,N′-tetraacetic acid (EGTA), ethylenediamine disuccinic acid (EDDS), ethylenediamine tetraacetic acid (EDTA), citric acid, polycarboxylates, oxalic acid, carbamoyl methylphosphine oxide (CMPO), crown ethers and mixtures thereof.
